(19) United States
(12) Patent Application Publication
(10) Pub. No.: US 2025/0346220 A1
(43) Pub. Date: Nov. 13, 2025

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventors: Jang Hun Jeong, Hwaseong-si (KR); Sheen Gil Kang, Hwaseong-si (KR)

(73) Assignees: HYUNDAI MOTOR COMPANY, Seoul (KR); KIA CORPORATION, Seoul (KR)

(21) Appl. No.: 18/904,855

(22) Filed: Oct. 2, 2024

(30) Foreign Application Priority Data
May 13, 2024 (KR) 10-2024-0062779

(51) Int. Cl. B60W 30/02; B60W 40/11

(52) U.S. Cl. CPC B60W 30/02; B60W 40/11; B60W 2510/0657; B60W 2510/083; B60W 2552/35

(57) ABSTRACT

An apparatus for controlling a vehicle includes a sensor configured to acquire information about a road. The apparatus also includes a processor configured to determine whether the vehicle passes through a speed bump, based on the information about the road. The processor is also configured to control a pitch motion and a bounce motion made as the vehicle passes through the speed bump, by determining a motor torque when the vehicle passes through the speed bump.

### CROSS-REFERENCE TO RELATED APPLICATION

This application claims the benefit of and priority to Korean Patent Application No. 10-2024-0062779, filed in the Korean Intellectual Property Office on May 13, 2024, the entire contents of which are hereby incorporated herein by reference.

### TECHNICAL FIELD

The present disclosure relates to an apparatus and a method for controlling a vehicle, and more particularly, to an apparatus and a method for controlling a vehicle, capable of controlling a motor to improve both a pitch motion and a bounce motion when the vehicle passes through a speed bump.

### BACKGROUND

When a vehicle passes through a speed bump, a user may feel a ride comfort degraded through a pitch motion (a motion in a direction rotating about an axle linked to a vehicle wheel) and a bounce motion (a motion in an up-down direction). An electric vehicle having only a motor (a front-wheel motor) provided in a front wheel may control a torque of the front-wheel motor to reduce the pitch motion, thereby improving the ride comfort.

In addition, an electric vehicle having the front-wheel motor and a motor (a rear-wheel motor) provided in a rear wheel may apply torques to the front-wheel motor and the rear-wheel motor in opposite directions, thereby reducing the bounce motion of a vehicle body.

However, because the pitch motion and the bounce motion interact to each other, an unintended pitch motion and an unintended bounce motion are made when the pitch motion and the bounce motion are simultaneously reduced. Accordingly, simultaneously controlling of the pitch motion and the bounce motion depending on a user request has a limitation.

### SUMMARY

The present disclosure has been made to solve the above-mentioned problems occurring in the prior art while advantages achieved by the prior art are maintained intact.

Aspects of the present disclosure provide an apparatus and a method for controlling a vehicle, capable of simultaneously controlling a pitch motion and a bounce motion based on a user request, by removing (e.g., decoupling) the interaction between the pitch motion and the bounce motion.

Other aspects of the present disclosure provide an apparatus and a method for controlling a vehicle, capable of transforming a pitch motion and a bounce motion into a vibration motion, calculating force to minimize the vibration motion by controlling damping speed, and determining a motor torque for realizing force to minimize the vibration motion.

Various aspects of the present disclosure provide an apparatus and a method for controlling vehicle, capable of simultaneously improving a pitch motion and a bounce motion by lowering a pitch rate and a bounce rate when the vehicle passes a speed bump, such that the ride comfort of a user is improved.

The technical problems to be solved by the present disclosure are not limited to the aforementioned problems. Other technical problems not mentioned herein should be more clearly understood from the following description by those having ordinary skill in the art to which the present disclosure pertains.

According to an embodiment of the present disclosure, an apparatus for controlling a vehicle is provided. The apparatus includes a sensor configured to acquire information about a road. The apparatus also includes a processor configured to determine whether the vehicle passes through a speed bump, based on the information about the road. The processor is also configured to control a pitch motion and a bounce motion made as the vehicle passes through the speed bump, by determining a motor torque when the vehicle passes through the speed bump.

According to an embodiment, the processor may be configured to produce a vibration motion equation by transforming a motion equation corresponding to the pitch motion and the bounce motion made as the vehicle passes through the speed bump, into be in a modal coordinate system.

According to an embodiment, the processor may be configured to calculate a first modal speed corresponding to a pitch angular speed and a second modal speed corresponding to a bounce speed, using the motion vibration equation.

According to an embodiment, the pitch angular speed may be calculated, based on a pitch angle made through the pitch motion.

According to an embodiment, the bounce speed may be calculated, based on a displacement in a vertical direction, which is made through the bounce motion.

According to an embodiment, the processor may be configured to calculate first modal force corresponding to the first modal speed and second modal force corresponding to the second modal speed, based on the vibration motion equation.

According to an embodiment, the processor may be configured to determine a first motor torque based on the first modal force, and determine a second motor torque based on the second modal force.

According to an embodiment, the processor may be configured to control a motor provided in a front wheel, based on the first motor torque, when the vehicle passes through the speed bump.

According to an embodiment, the processor may be configured to control a motor provided in a rear wheel, based on the second motor torque, when the vehicle passes through the speed bump.

According to another embodiment of the present disclosure, a method for controlling a vehicle is provided. The method includes determining whether the vehicle passes through a speed bump, based on information about a road. The method also includes controlling a pitch motion and a bounce motion made as the vehicle passes through the speed bump, by determining a motor torque when the vehicle passes through the speed bump.

According to an embodiment, the method may further include producing a vibration motion equation by transforming a motion equation corresponding to the pitch motion and the bounce motion made as the vehicle passes through the speed bump, into be in a modal coordinate system.

According to an embodiment, the method may further include calculating a first modal speed corresponding to a pitch angular speed and a second modal speed corresponding to a bounce speed, using the motion vibration equation.

According to an embodiment, the pitch angular speed may be calculated, based on a pitch angle made through the pitch motion.

According to an embodiment, the bounce speed may be calculated, based on a displacement in a vertical direction, which is made through the bounce motion.

According to an embodiment, the method may further include calculating first modal force corresponding to the first modal speed and second modal force corresponding to the second modal speed, based on the vibration motion equation.

According to an embodiment, the method may further include determining a first motor torque based on the first modal force, and determining a second motor torque based on the second modal force.

According to an embodiment, the method may further include controlling a motor provided in a front wheel, based on the first motor torque, when the vehicle passes through the speed bump.

According to an embodiment, the method may further include controlling a motor provided in a rear wheel, based on the second motor torque, when the vehicle passes through the speed bump.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a view illustrating a configuration of an apparatus for controlling a vehicle, according to an embodiment of the present disclosure;

FIG. 2 is a view schematically illustrating operation of an apparatus for controlling a vehicle, according to an embodiment of the present disclosure;

FIG. 3 is a view schematically illustrating a parameter of a motion equation produced, according to an embodiment of the present disclosure;

FIG. 4 is a view schematically illustrating an operation for calculating a first modal speed and a second modal speed, according to an embodiment of the present disclosure;

FIG. 5 is a view schematically illustrating an operation for calculating first modal force and second modal force, according to an embodiment of the present disclosure;

FIG. 6 is a view schematically illustrating an operation for calculating a torque of a front-wheel driving motor and a torque of a rear-wheel driving motor, according to an embodiment of the present disclosure;

FIG. 7 is a flowchart illustrating a method for controlling a vehicle, according to an embodiment of the present disclosure; and

FIG. 8 is a view illustrating the configuration of a computing system to execute a method according to an embodiment of the present disclosure.

### DETAILED DESCRIPTION

Hereinafter, embodiments of the present disclosure are described in detail with reference to accompanying drawings. In adding the reference numerals to the components of each drawing, it should be noted that the identical or equivalent components are designated by the identical numeral even when the components are displayed on different drawings. In addition, in the following description, detailed descriptions of well-known features or functions have been omitted in order not to unnecessarily obscure the gist of the present disclosure.

In the following description, terms such as first, second, “A”, “B”, “(a)”, “(b)”, and the like may be used. These terms are merely intended to distinguish one component from another component. The terms do not limit the nature, sequence, or order of the constituent components. In addition, unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings equal to the contextual meanings in the relevant field of art. The terms should not be interpreted as having ideal or excessively formal meanings unless clearly defined as having such in the present application.

When a component, device, module, element, or the like of the present disclosure is described as having a purpose or performing an operation, function, or the like, the component, device, or element should be considered herein as being “configured to” meet that purpose or perform that operation or function.

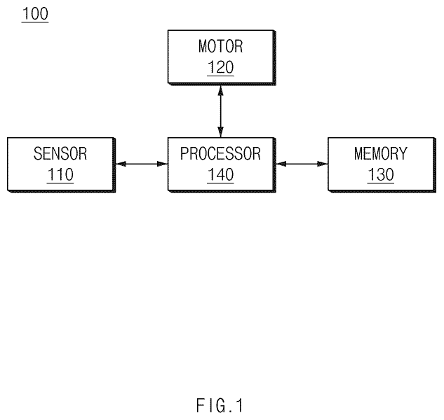

FIG. 1 is a view illustrating a configuration of an apparatus for controlling a vehicle, according to an embodiment of the present disclosure.

As illustrated in FIG. 1, according to an embodiment of the present disclosure, an apparatus (vehicle controlling device) 100 for controlling a vehicle may include a sensor 110, a motor 120, a memory 130, and a processor 140.

The sensor 110 may acquire information about the driving of the vehicle. Hereinafter, the information about the driving of the vehicle is referred to as “driving information”, for the convenience of explanation. According to an embodiment, the driving information may include at least one of a surrounding image acquired in real time by the vehicle while driving, status information made by a pitch motion (pitch movement) of the vehicle, a roll motion (roll movement) of the vehicle, a bounce motion (bounce movement) of the vehicle, or a combination thereof. According to an embodiment, the sensor 110 may include at least one of an image sensor, a wheel sensor, a speed sensor, a tilt sensor, a height sensor, a weight sensor, a heading sensor, a yaw sensor, an acceleration sensor, a gyro sensor, a tire sensor, or a combination thereof.

The motor 120 may provide driving force to drive the vehicle by using power stored in a battery. According to an embodiment, the motor 120 may be provided in each of a front wheel and a rear wheel to transfer the power to the front wheel and the rear wheel of the vehicle.

The memory 130 may store at least one algorithm to compute or execute various instructions for the operation of the vehicle control device according to an embodiment of the present disclosure. According to an embodiment, the memory 130 may store at least one instruction executed by the processor 140, and the instruction may allow the vehicle control device to operate according to an embodiment. The memory 130 may include at least one storage medium of at least one a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, or an optical disc.

The processor 140 may be implemented by various processing devices, such as a microprocessor embedded therein with a semiconductor chip to operate or execute various instructions, and may control the vehicle control device according to an embodiment. The processor 140 may be electrically connected to the sensor 110, the motor 120, and the memory 130 through a wired cable or various circuits to transmit an electrical signal including a control command to execute an arithmetic operation or data processing related to a control operation and/or communication. The processor 140 may include at least one of a central processing unit, an application processor, a communication processor (CP), or any combination thereof.

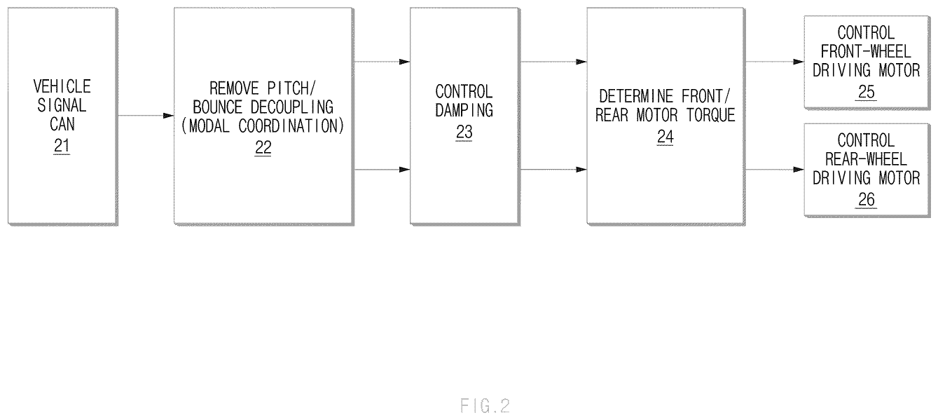

According to an embodiment, the processor 140 may determine whether the vehicle passes through a speed bump based on information about a road. The processor 140 may determine a motor torque depending on whether the motor is provided in both the front wheel and the rear wheel, when the vehicle is determined as passing through the speed bump, to control the pitch motion and the bounce motion made as the vehicle passes through the speed bump. Detailed operation of the processor 140, according to an embodiment, is described below with reference to FIGS. 2-6.

FIG. 2 is a view schematically illustrating operation of the vehicle control device, according to an embodiment of the present disclosure.

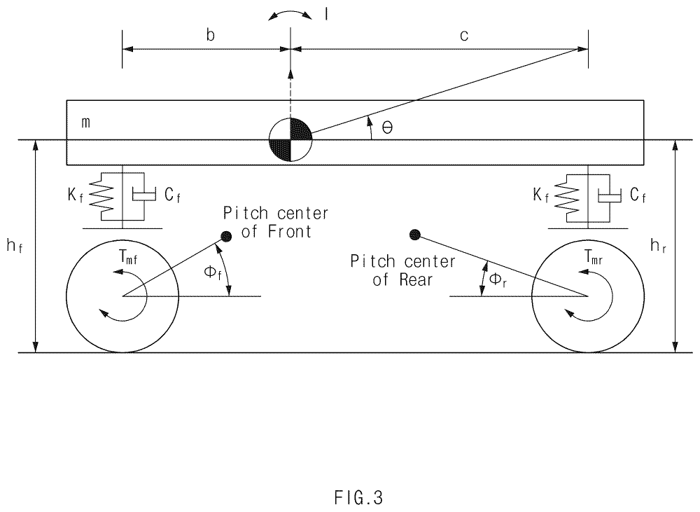

As illustrated in FIG. 2, the processor 140 may perform an operation 22 for removing (e.g., decoupling) the coupling between i) a pitch angle of a vehicle body that is made through a pitch motion and ii) a displacement (or a vertical displacement) in the vertical direction that is made through the bounce motion, when the pitch angle of the vehicle body and the displacement in the vertical direction are acquired through a vehicle signal (CAN) 21 corresponding to the driving information of the vehicle when the vehicle passes through the speed bump. The processor 140 may also perform an operation 23 an operation for increasing a damping coefficient. The processor 140 may thus control damping to minimize the vibration of the vehicle body. The processor 140 may further perform an operation 24 for determining the torque of the motor provided in the front wheel and the torque of the motor provided in the rear wheel. The processor 140 may also perform an operation 25 for controlling each of the motor provided in the front wheel and the motor provided in the rear wheel, based on the determined torque of the motor. The details of the operations 21 to 25, according to an embodiment, are described below with reference to FIGS. 3-6.

FIG. 3 is a view schematically illustrating a parameter of a motion equation produced, according to an embodiment of the present disclosure.

Referring to FIG. 3, the processor 140 may produce a motion equation corresponding to the pitch motion and the bounce motion made when the vehicle passes through the speed bump, by using the driving information of the vehicle acquired through the sensor 110 when the vehicle passes through the speed bump. According to an embodiment, the motion equation may be expressed as Equation 1.

$$[ M ] ( \begin{matrix}\ddot{Z} \\ \ddot{θ}\end{matrix} ) + [ C ] ( \begin{matrix}\dot{Z} \\ \dot{θ}\end{matrix} ) + [ K ] ( \begin{matrix}Z \\ θ\end{matrix} ) = [ W ] + [ {B}_{f} {B}_{r} ] ( \begin{matrix}{F}_{xf} \\ {F}_{xr}\end{matrix} ) \qquad 〈 Equation 1 〉$$

### In Equation 1,

$$[ M ] = [ \begin{matrix}m & 0 \\ 0 & I\end{matrix} ] , \\ [ C ] = [ \begin{matrix}{C}_{f} + {C}_{r} & {C}_{r} c - {C}_{f} b \\ {C}_{r} c - {C}_{f} b & {C}_{f} {b}^{2} + {C}_{r} {c}^{2}\end{matrix} ] , [ K ] = [ \begin{matrix}{K}_{f} + {K}_{r} & {K}_{r} c - {K}_{f} b \\ {K}_{r} c - {K}_{f} b & {K}_{f} {b}^{2} + {K}_{r} {c}^{2}\end{matrix} ] , [ {B}_{f} ] = ( \begin{matrix}- tan {ϕ}_{f} \\ - {h}_{f} + tan {ϕ}_{f} b\end{matrix} ) , \\ [ {B}_{r} ] = ( \begin{matrix}tan {ϕ}_{r} \\ - {h}_{r} + tan {ϕ}_{r} c\end{matrix} ) , [ W ] = ( \begin{matrix}{C}_{r} {\dot{z}}_{0 r} + {C}_{f} {\dot{z}}_{0 f} + {K}_{r} {z}_{0 r} + {K}_{f} {z}_{0 f} \\ {C}_{r} c {\dot{z}}_{0 r} - {C}_{f} b {\dot{z}}_{0 f} + {K}_{r} {cz}_{0 r} - {K}_{f} {bz}_{0 f}\end{matrix} ) .$$

C: damping matrix
K: Stiffness matrix
m: Mass of vehicle
I: Moment of pitch Inertia of vehicle body
C_{f}: Front-wheel suspension damping coefficient
Cᵣ: Rear wheel suspension damping coefficient
K_{f}: Front wheel suspension stiffness coefficient
Kᵣ: Rear wheel suspension stiffness coefficient
b: The distance from front-wheel axle to center of gravity of vehicle
c: The distance from rear-wheel axle to center of gravity of vehicle
h_{f}: Height from front-wheel axle to center of gravity of vehicle
hᵣ: Height from rear-wheel axle to center of gravity of vehicle
Φf: Front wheel suspension anti-squat angle
Φr: Rear wheel suspension anti-squat angle
z: Vertical displacement of vehicle body (bounce)
θ: Pitch angle of vehicle body
z_dot: Bounce speed
θ_dot: Pitch angular speed

In Equation 1, since matrices of ‘M’, ‘C’, and ‘K’ are not diagonal matrices, the bounce (z) and the pitch angle (θ) of the vehicle body are coupled to each other. Accordingly, the processor 140 may remove (decouple) the coupling of the bounce (z) and the pitch angle (θ) of the vehicle body to transform the bounce (z) and the pitch angle (θ) to be in a modal coordinate system to simultaneously control the bounce motion and the pitch motion based on a user request. The processor 140 may rearrange the motion equation of Equation 1 to be Equation 2. According to an embodiment, the processor 140 may rearrange Equation 1 to be Equation 2 on the assumption that ‘W’ (the force in the initial state) of Equation 1 is ‘0’.

$$M \ddot{x} + C \dot{x} + K x = B {T}_{m} \qquad 〈 Equation 2 〉$$

In Equation 2, x=[z θ]^{T}, Tₘ=[T_{mf} Tₘᵣ]^{T}, Tmf is a front-wheel driving motor torque, and Tmr is a rear-wheel driving motor torque.

The processor 140 may produce a vibration motion equation in a modal coordinate system by transforming an x coordinate system into a q coordinate system through Equation 2. According to an embodiment, the vibration motion equation may be expressed as Equation 3.

$$\ddot{q} + \tilde{C} \dot{q} + \tilde{K} q = \tilde{B} {T}_{m} \qquad 〈 Equation 3 〉$$

In this case, x=Vq, q=V⁻¹x and ‘V’ is an eigen vector of

$${K}_{n} ( \frac{K}{M} ) .$$

When V^{T}MV=I (I is a unit matrix), \tilde{C}=V^{T}CV, \tilde{K}=V^{T}KV, \tilde{B}=V^{T}B may be expressed.

In this case, since \tilde{C} is a quasi-diagonal matrix and \tilde{K} becomes a diagonal matrix, the components of q (bounce(z) and pitch angle (θ)) in Equation 3 are not coupled and independent from each other.

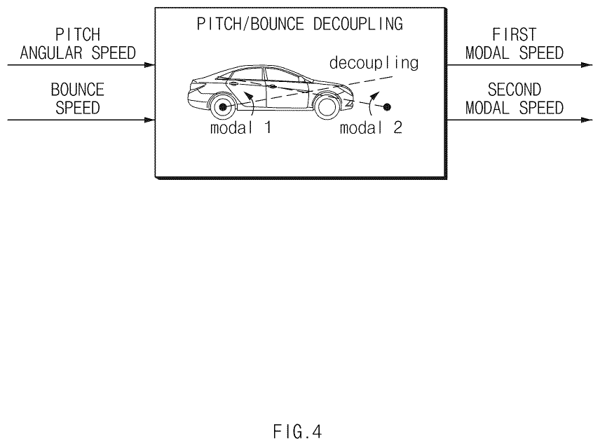

FIG. 4 is a view schematically illustrating an operation for calculating a first modal speed and a second modal speed, according to an embodiment of the present disclosure.

Referring to FIG. 4, the processor 140 may calculate a pitch angular speed (θ_dot) by differentiating the pitch angle (θ) acquired through the sensor 110. The processor 140 may also calculate the bounce speed (z_dot) by differentiating the bounce (z), when the vehicle passes through the speed bump.

The processor 140 may input the pitch angular speed (θ_dot) and the bounce speed (z_dot) into Equation 2 and may calculate a first modal speed corresponding to the pitch angular speed having no coupling and a second modal speed corresponding to the bounce speed having no coupling, through Equation 3. In an embodiment, the first modal speed and the second modal speed may be calculated as elements of a 1×2 matrix of ‘q_dot’ of Equation 3.

The processor 140 may control damping \tilde{B}Tₘ corresponding to external force to minimize the vibration motion, based on ‘q_dot’ in Equation 3. The processor 140 may express \tilde{B}Tₘ in the form of the product of a diagonal matrix (diag(G₁, G₂)), in which the elements of (1, 1), and (2, 2) have values, and the elements of (1,2) and (2,1) are ‘0’, and ‘q_dot’, which is expressed as Equation 4 according to an embodiment.

$$\tilde{B} {T}_{m} = - diag ( {G}_{1} , {G}_{2} ) \dot{q} \qquad 〈 Equation 4 〉$$

The processor 140 use Equation 5 produced by reflecting Equation 4 in Equation 3, and may tune parameters of diag(G₁, G₂) to increase the damping coefficient such that \tilde{C}+diag(G₁, G₂) vibration motion is minimized by reducing ‘q_dot’ through Equation 5.

$$\ddot{q} + [ \tilde{C} + diag ( {G}_{1} , {G}_{2} ) ) ] \dot{q} + \tilde{K} q = 0 \qquad 〈 Equation 5 〉$$

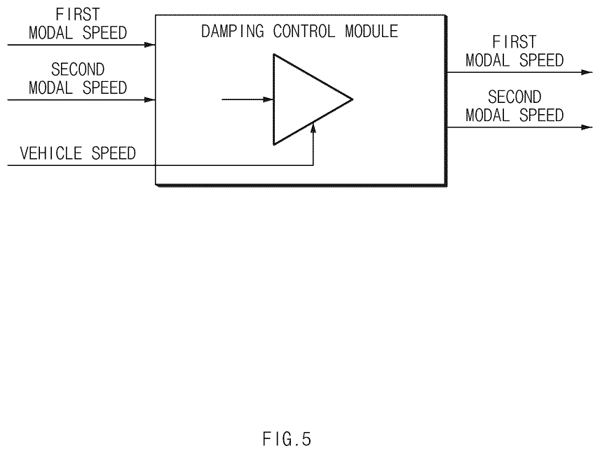

FIG. 5 is a view schematically illustrating an operation for calculating first modal force and second modal force, according to an embodiment of the present disclosure.

Referring to FIG. 5, the processor 140 may calculate a modal force (\tilde{B}Tₘ) by inputting a first modal speed and a second modal speed to ‘q_dot’ of Equation 4. The modal force may include the first modal force corresponding to the first modal speed and the second modal force corresponding to the second modal speed.

Equation 4 may be transformed into Equation 6. The processor 140 may use Equation 6 to implement force to minimize vibration motion using a torque of the front-wheel driving motor and a torque of the rear-wheel driving motor.

$${T}_{m} = - {\tilde{B}}^{- 1} diag ( {G}_{1} , {G}_{2} ) \dot{q} \qquad 〈 Equation 6 〉$$

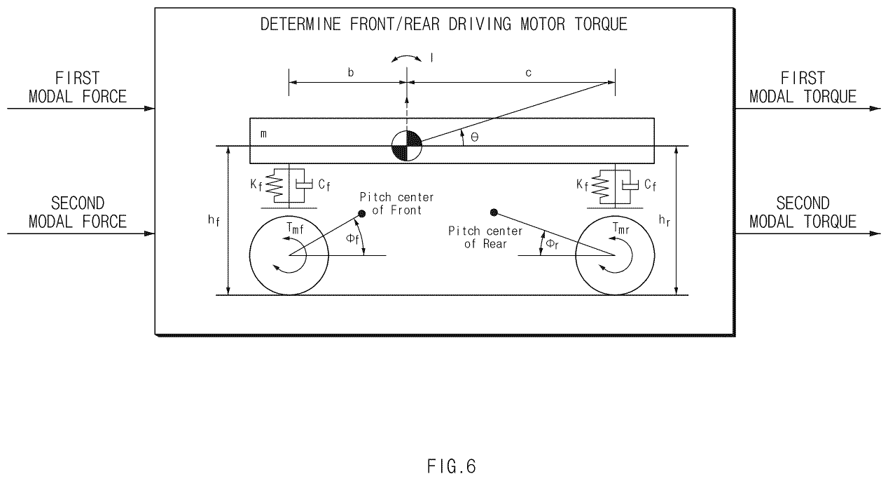

FIG. 6 is a view schematically illustrating an operation for calculating a torque of a front-wheel driving motor and a torque of a rear-wheel driving motor, according to an embodiment of the present disclosure.

Referring to FIG. 6, the processor 140 may determine the torque T_{mf} of the front-wheel driving motor as the first motor torque, based on the first modal force and Equation 6. The processor 140 may also determine the torque Tₘᵣ of the rear-wheel driving motor as the second motor torque, based on the second modal force and Equation 6.

Equation 6 may be transformed into Equation 7. The processor 140 may use Equation 7 to control the pitch angular speed and the bounce speed using the torque of the driving motor.

$${T}_{m} = - {\tilde{B}}^{- 1} diag ( {G}_{1} , {G}_{2} ) {V}^{- 1} \dot{x} \qquad 〈 Equation 7 〉$$

In Equation 7,

$$\tilde{B} = {V}^{T} B , \\ [ {B}_{f} ] = ( \begin{matrix}- tan {ϕ}_{f} \\ - {h}_{f} + tan {ϕ}_{f} b\end{matrix} ) , [ {B}_{r} ] = ( \begin{matrix}tan {ϕ}_{r} \\ - {h}_{r} + tan {ϕ}_{r} c\end{matrix} )$$

The processor 140 may adjust the pitch angular speed (θ_dot) and the bounce speed (z_dot), which are components of x_dot in Equation 7, using the torque Tmf of the front-wheel driving motor and the torque Tₘᵣ of the rear-wheel driving motor such that the movement of the vehicle is controlled to the pitch motion and the bounce motion required by the user.

According to an embodiment, when the torque T_{mf} of the front-wheel driving motor is determined as the first motor torque, and when the vehicle passes through the speed bump, the processor 140 may control the motor provided in the front wheel based on the first motor torque. When the torque Tₘᵣ of the rear-wheel driving motor is determined as the second motor torque, and when the vehicle passes through the speed bump, the motor provided in the rear wheel may be controlled based on the second motor torque.

According to an embodiment, the processor 140 may control the motor provided in the front wheel based on the first motor torque and the motor provided in the rear wheel based on the second motor torque, when the vehicle passes through the speed bump, and may simultaneously improve the pitch motion and the bounce motion by lowering the pitch rate (rad/s) and the bounce rate (m/s) of the vehicle to minimize the vibration motion of the vehicle, thereby improving the ride comfort of the user.

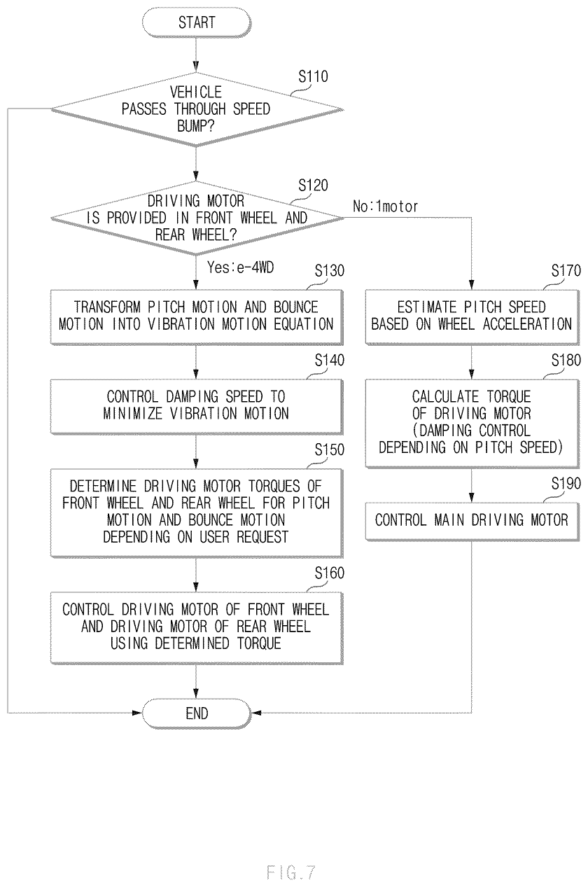

FIG. 7 is a flowchart illustrating a method for controlling a vehicle, according to an embodiment of the present disclosure.

As illustrated in FIG. 7, in an operation S110, the processor 140 may determine whether the vehicle passes through the speed bump while straight-line driving, based on the information about the road.

In an operation S120, the processor 140 may determine whether the driving motor is provided in both the front wheel and the rear wheel, when the vehicle is determined as passing through the speed bump.

When the driving motor is determined as being provided in both the front wheel and the rear wheel, the processor 140 may perform an operation S130 to transform the pitch motion and the bounce motion made when the vehicle passes through the speed bump, into a vibration motion equation.

According to an embodiment, in the operation S130, the processor 140 may make a motion equation corresponding to the pitch motion and the bounce motion made when the vehicle passes through the speed bump, based on the driving information of the vehicle which is acquired through the sensor 110 when the vehicle passes through the speed bump. According to an embodiment, the motion equation may be expressed as Equation 1.

In Equation 1, since matrices of ‘M’, ‘C’, and ‘K’ are not diagonal matrices, the bounce (z) and the pitch angle (θ) of the vehicle body are coupled to each other. Accordingly, the processor 140 may remove (decouple) the coupling of the bounce (z) and the pitch angle (θ) of the vehicle body to transform the bounce (z) and the pitch angle (θ) into a modal coordinate system to simultaneously control the bounce motion and the pitch motion depending on a user request. The processor 140 may rearrange the kinetic equation of Equation 1 into Equation 2. According to an embodiment, the processor 140 may rearrange Equation 1 into Equation 2, on the assumption that ‘W’ (initial force) of Equation 1 is ‘0’.

The processor 140 may generate a vibration motion equation in a modal coordinate system by transforming an X coordinate system into a q coordinate system through Equation 2. According to an embodiment, the vibration motion equation may be expressed as Equation 3.

The processor 140 may calculate the pitch angular speed (θ_dot) by differentiating the pitch angle (θ) acquired through the sensor 110, and calculate the bounce speed (z_dot) by differentiating the bounce (z), when the vehicle passes through the speed bump.

The processor 140 may input the pitch angular speed (θ_dot) and the bounce speed (z_dot) into Equation 2 and may calculate a first modal speed corresponding to the pitch angular speed having no coupling and a second modal speed corresponding to the bounce speed having no coupling, through Equation 3. In an embodiment, the first modal speed and the second modal speed may be calculated as elements of a 1×2 matrix of ‘q_dot’ of Equation 3.

When the first modal speed and the second modal speed are calculated using the vibration motion equation transformed in the operation S130, the processor 140 may perform an operation S140 to control damping \tilde{B}Tₘ corresponding to external force to minimize the vibration motion, based on and ‘q_dot’ in Equation 3.

According to an embodiment, in the operation S140, the processor 140 may express \tilde{B}Tₘ in the form of the product of a diagonal matrix (diag(G₁, G₂)), in which the elements of (1, 1), and (2, 2) have values, and the elements of (1,2) and (2,1) are ‘0’, and ‘q_dot’, which is expressed as Equation 4 according to an embodiment, such that the damping of speed is controlled.

The processor 140 may use Equation 5, produced by reflecting Equation 4 in Equation 3, to tune parameters of diag(G₁, G₂) to increase the damping coefficient C+diag(G₁, G₂) such that vibration motion is minimized by reducing ‘q_dot’ through Equation 5.

In an operation S150, the processor 140 may determine the torque of the front-wheel driving motor and the torque of the rear-wheel driving motor for the pitch motion and the bounce motion depending on the user request.

According to an embodiment, in the operation S150, the processor 140 may calculate a modal force (\tilde{B}Tₘ) by inputting the first modal speed and the second modal speed to ‘q_dot’ of Equation 4. The modal force may include the first modal force corresponding to the first modal speed and the second modal force corresponding to the second modal speed.

The processor 140 may transform Equation 4 into Equation 6 to implement force to minimize the vibration motion using a torque of the front-wheel driving motor and a torque of the rear-wheel driving motor.

The processor 140 may determine the torque T_{mf} of the front-wheel driving motor as the first motor torque based on the first modal force and Equation 6. The processor 140 may also determine the torque Tₘᵣ of the rear-wheel driving motor as the second motor torque based on the second modal force and Equation 6.

The processor 140 may transform Equation 6 into Equation 7 to control the pitch angular speed and the bounce speed using the torque of the driving motor.

The processor 140 may adjust the pitch angular speed (θ_dot) and the bounce speed (z_dot), which are elements of x_dot in Equation 7, using the torque T_{mf} of the front-wheel driving motor and the torque Tₘᵣ of the rear-wheel driving motor such that the movement of the vehicle is controlled to the pitch motion and the bounce motion depending on the user request.

In an operation S160, the processor 140 may control the front-wheel driving motor and the rear-wheel driving motor using the torque of the driving motor determined.

According to an embodiment, in the operation S160, when the torque T_{mf} of the front-wheel driving motor is determined as the first motor torque, and when the vehicle passes through the speed bump, the processor 140 may control the motor provided in the front wheel based on the first motor torque. When the torque Tₘᵣ of the rear-wheel driving motor is determined as the second motor torque, and when the vehicle passes through the speed bump, the motor provided in the rear wheel may be controlled based on the second motor torque.

According to an embodiment, in the operation S160, the processor 140 may control the motor provided in the front wheel based on the first motor torque and the motor provided in the rear wheel based on the second motor torque, when the vehicle passes through the speed bump, and may simultaneously improve the pitch motion and the bounce motion by lowering the pitch rate (rad/s) and the bounce rate (m/s) of the vehicle to minimize the vibration motion of the vehicle, thereby improving the ride comfort of the user.

When it is determined which the driving motor is not provided in both the front wheel and the rear wheel in the operation S120, the processor 140 may perform an operation S170 to estimate the pitch speed using the acceleration of left and right wheels of the vehicle.

In an operation S180, the processor 140 may calculate a torque of the driving motor by controlling damping according to the pitch speed.

In an operation S190, when the torque of the driving motor is calculated, the processor 140 may control the main driving motor to the calculated torque.

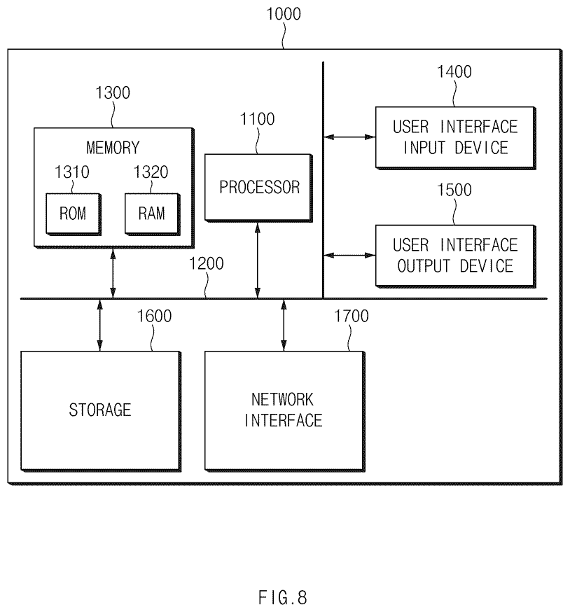

FIG. 8 is a view illustrating the configuration of a computing system to execute a method according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the methods or algorithms described in connection with the embodiments of the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

As described above, according to embodiments of the present disclosure, in an apparatus and a method for controlling a vehicle, pitch motion and bounce motion may be simultaneously controlled based on the user request, by removing (e.g., decoupling) the interaction between the pitch motion and the bounce motion.

According to embodiments of the present disclosure, in the apparatus and the method for controlling the vehicle, the pitch motion and the bounce motion may be transformed into the vibration motion, force to minimize the vibration motion may be calculated by controlling damping speed, and the motor torque for realizing force to minimize the vibration motion may be determined.

According to embodiments of the present disclosure, in the apparatus and the method for controlling the vehicle, the pitch motion and the bounce motion may be simultaneously improved by lowering the pitch rate and the bounce rate when the vehicle passes the speed bump, such that the ride comfort of the user is improved.

The above description is merely illustrative of the technical idea of the present disclosure, and various modifications and modifications may be made by one having ordinary skill in the art without departing from the essential characteristics of the present disclosure.

Therefore, the descried embodiments of the present disclosure are provided to explain the spirit and scope of the present disclosure, but not to limit them, such that the spirit and scope of the present disclosure is not limited by the embodiments. The scope of the present disclosure should be construed on the basis of the accompanying claims, and all the technical ideas within the scope equivalent to the claims should be included in the scope of the present disclosure.

Hereinabove, although the present disclosure has been described with reference to example embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

What is claimed is:

1. An apparatus for controlling a vehicle, the apparatus comprising:
a sensor configured to acquire information about a road; and
a processor configured to
determine whether the vehicle passes through a speed bump based on the information about the road, and
control a pitch motion and a bounce motion made as the vehicle passes through the speed bump, by determining a motor torque when the vehicle passes through the speed bump.

2. The apparatus of claim 1, wherein the processor is configured to produce a vibration motion equation by transforming a motion equation corresponding to the pitch motion and the bounce motion made as the vehicle passes through the speed bump, to be in a modal coordinate system.

3. The apparatus of claim 2, wherein the processor is configured to calculate i) a first modal speed corresponding to a pitch angular speed and ii) a second modal speed corresponding to a bounce speed, using the motion vibration equation.

4. The apparatus of claim 3, wherein the pitch angular speed is calculated based on a pitch angle made through the pitch motion.

5. The apparatus of claim 3, wherein the bounce speed is calculated based on a displacement in a vertical direction that is made through the bounce motion.

6. The apparatus of claim 3, wherein the processor is configured to calculate i) first modal force corresponding to the first modal speed and ii) second modal force corresponding to the second modal speed, based on the vibration motion equation.

7. The apparatus of claim 6, wherein the processor is configured to:
determine a first motor torque based on the first modal force; and
determine a second motor torque based on the second modal force.

8. The apparatus of claim 7, wherein the processor is configured to control a motor provided in a front wheel based on the first motor torque, when the vehicle passes through the speed bump.

9. The apparatus of claim 7, wherein the processor is configured to control a motor provided in a rear wheel based on the second motor torque, when the vehicle passes through the speed bump.

10. A method for controlling a vehicle, the method comprising:
determining, based on information about a road, whether the vehicle passes through a speed bump; and
controlling a pitch motion and a bounce motion made as the vehicle passes through the speed bump, by determining a motor torque when the vehicle passes through the speed bump.

11. The method of claim 10, further comprising producing a vibration motion equation by transforming a motion equation corresponding to the pitch motion and the bounce motion made as the vehicle passes through the speed bump, to be in a modal coordinate system.

12. The method of claim 11, further comprising calculating i) a first modal speed corresponding to a pitch angular speed and ii) a second modal speed corresponding to a bounce speed, using the motion vibration equation.

13. The method of claim 12, wherein the pitch angular speed is calculated based on a pitch angle made through the pitch motion.

14. The method of claim 12, wherein the bounce speed is calculated based on a displacement in a vertical direction, that is made through the bounce motion.

15. The method of claim 12, further comprising i) calculating first modal force corresponding to the first modal speed and ii) second modal force corresponding to the second modal speed, based on the vibration motion equation.

16. The method of claim 15, further comprising:
determining a first motor torque based on the first modal force; and
determining a second motor torque based on the second modal force.

17. The method of claim 16, further comprising controlling a motor provided in a front wheel based on the first motor torque, when the vehicle passes through the speed bump.

18. The method of claim 16, further comprising controlling a motor provided in a rear wheel based on the second motor torque, when the vehicle passes through the speed bump.
